(19) United States
(12) Patent Application Publication
(10) Pub. No.: US 2002/0083843 A1
(43) Pub. Date: Jul. 4, 2002

(54) Coffee maker

(76) Inventors: Peter Dam, Hoogeveen (NL); Hans J. Kodden, Hoogeveen (NL); Marcel Hendrikus Simon Weijers, Hoogeveen (NL)

Correspondence Address: Corporate Patent Counsel, U.S. Philips Corporation, 580 White Plains Road, Tarrytown, NY, 10591, US

(21) Appl. No.: 10/023,068

(22) Filed: Dec. 17, 2001

(30) Foreign Application Priority Data
Dec. 20, 2000 (EP) 00204647.2

(51) Int. Cl. A47J 31/00

(52) U.S. Cl. 99/307; 99/280

(57) ABSTRACT

A coffee maker with a water reservoir (4) provided with a filling opening (41) and a reservoir outlet (11); a heater-pump (12) for heating and supplying water with an inlet (14) which is connected to said reservoir outlet (11) and with an outlet (15); a filter holder (5) with a filter inlet (51) connected to said heater-pump (12) and a filter outlet (52), which filter holder has an upper portion (54) having a larger horizontal cross-sectional surface area than a lower portion (55) thereof; and at least in the operating condition, a coffee jug (9) under said filter holder (5), which coffee jug has an inflow opening for brewed coffee downstream of said filter outlet (52), wherein at least a portion of the water reservoir (4) is located next to the filter holder (5); the portion of the water reservoir (4) located next to said filter holder (5) at a level of said lower portion (55) of said filter holder extending to below said upper portion (54) of said filter holder.

The invention relates to a coffee maker comprising:

a water reservoir provided with a water fill opening and a reservoir outlet;

a heater-pump for heating and supplying water, with an inlet which is connected to said reservoir outlet and with an outlet;

a filter holder with a filter inlet connected to said heater-pump and a filter outlet, which filter holder has an upper portion which has a larger horizontal cross-sectional surface area than a lower portion thereof; and

at least in an operational state, a coffee jug underneath said filter holder, which jug has an inflow opening for receiving coffee downstream of said filter outlet,

while at least a portion of the water reservoir is situated next to the filter holder.

Such a coffee maker is known from European patent application 0 988 819.

In the coffee maker according to this document, the water reservoir is situated above the filter holder. A coffee maker is obtained thereby which has a small surface area.

A disadvantage of this known appliance, however, is its comparatively high center of gravity, especially if the reservoir is full, with the result that the appliance easily falls over if it is knocked against. In addition, a coffee maker in which the water reservoir lies above the filter device is high, so that it occupies much space, for example, on a kitchen work top.

A coffee maker is known from U.S. Pat. No. 4,579,050 in which the water reservoir, viewed from an upper side of the coffee maker, is U-shaped and partly surrounds a filter device. The water reservoir here extends above the beverage holder.

This appliance, however, has the disadvantage that the capacity of the water reservoir in relation to the surface area occupied by the coffee maker is comparatively small, so that the capacity is limited. This is of lesser importance for the commercially available coffee maker in accordance with this patent, the Philips “Café Duo”, because this is specially designed for making no more than two cups of coffee.

It is an object of the invention to provide a coffee maker in which a water reservoir situated at least for the major part above the coffee jug is combined on the one hand with a comparatively low constructional configuration and on the other hand with a comparatively small support surface area.

According to the invention, this object is achieved by means of a coffee maker which is characterized in that that portion of the water reservoir which is situated laterally of the filter holder extends from the level of said lower portion of said filter holder up to next to said upper portion of said filter holder.

Since the water reservoir extends next to the filter holder to below the comparatively wide upper portion of the filter holder, the space present below the portion of the filter having the greatest cross-sectional area is at least partly utilized for the storage of water. This renders it possible, given a certain net reservoir capacity, to reduce the outer dimensions of the water reservoir. The height and/or the projected horizontal surface area of the coffee maker can be limited thereby.

Particularly advantageous embodiments of the invention are defined in the dependent claims.

Further aspects, details, and embodiments will be explained in more detail below with reference to an embodiment shown in the drawing, in which:

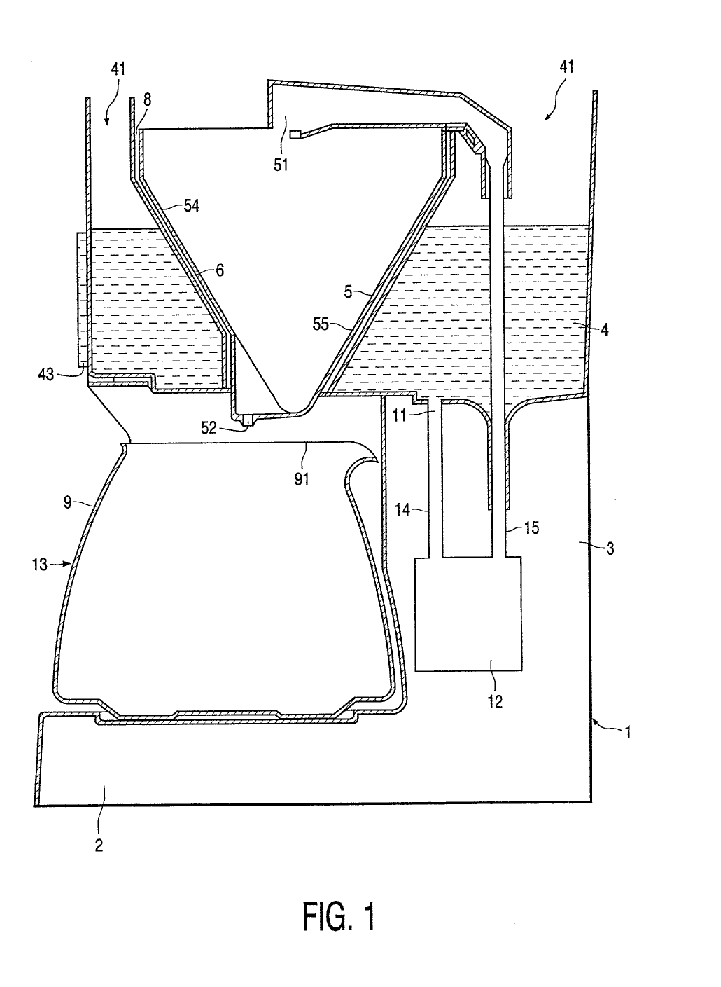

FIG. 1 shows a first embodiment of a coffee maker according to the invention in vertical sectional view, and

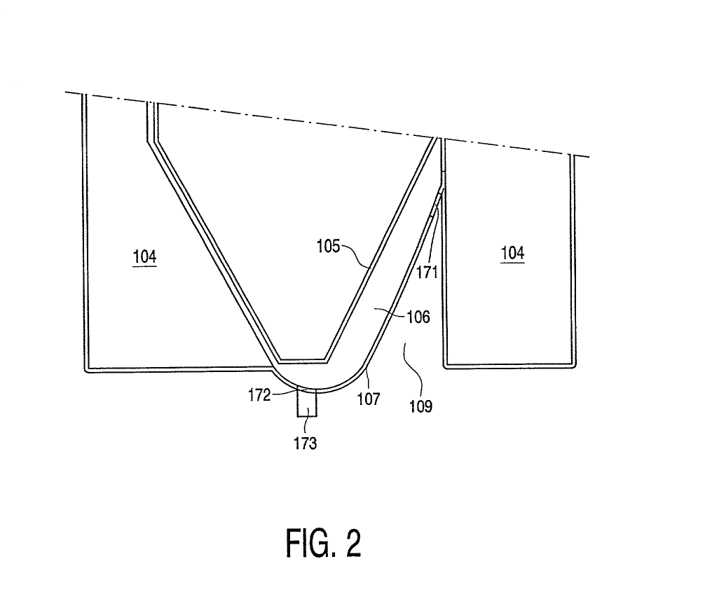

FIG. 2 shows a lower portion of a filter holder and a filter holder of a coffee maker in a second embodiment of the invention in vertical sectional view.

The coffee maker 1 shown in FIG. 1 has a base 2 and a housing 3 which rises from the base 2 at the rear of the coffee maker 1. A water reservoir 4 is provided in the housing 3. The water reservoir 4 is connected to an inlet 51 of a filter holder 5 via a reservoir outlet 11 and a heater-pump 12 which has an inlet 14 and an outlet 15. A beverage holder 9 in the form of a coffee jug is placed below the filter holder 5, which jug is in an operational position in FIG. 1. The coffee jug 9 has an inflow opening 91 which is situated opposite a filter outlet 52 in the operational state and which is in communication with the filter outlet 52 in the operational state, such that coffee flows from the filter holder 5 into the coffee jug 9.

The filter holder 5 has an upper portion 54 which has a larger horizontal cross-sectional surface area than a lower portion 55 of the filter holder. The portion of the water reservoir 4 situated next to the filter holder 5 here extends to below the upper portion 54. The net contents of the water reservoir 4 are increased thereby, the horizontal surface area of the water reservoir remaining the same. This renders it possible to make the reservoir smaller at the lower side as compared with known water reservoirs, while still the volume of the reservoir, the support surface area of the coffee maker, and the height of the coffee maker remain substantially the same.

Before the preparation of the coffee, the water reservoir is filled in that water is introduced into the reservoir 4 via the water fill opening 41. During the preparation of the coffee, water is moved from the water reservoir 4 through the heater-pump 12 and the filter inlet 51 into the filter holder 5. The heater-pump 12 is constructed as a flow heater 12 which heats the water, such that it is brought to the boil. When reaching boiling point, part of the water expands owing to the evolving water vapor, so that heated liquid water is pressed upwards and is moved into the filter inlet 51 via the outlet 15. The water reservoir 4 is situated mainly above the coffee jug 9. Heated water is pressed up more evenly as a result of this than in a coffee maker with a water reservoir situated mainly next to the coffee jug, because the water has to cover a smaller height difference from the reservoir outlet 11 to the filter inlet 51 than if the reservoir outlet 11 were situated next to or lower than the coffee jug. This means that a lower pressure is required for moving the water from the reservoir outlet 11 to the filter inlet 51. All this results in a quieter pump behavior.

A residual space 6 is reserved in the water reservoir 4, in which a portion of the filter holder 5 is accommodated. The filter holder 5 in the example shown is laterally surrounded by the water reservoir. The filter holder 5 and the residual space 6 each have an upper portion which has a greater horizontal cross-sectional surface area than a corresponding lower portion. Since the water reservoir 4 encloses the filter holder 5, moreover, the filter holder 5 is kept in position by the water reservoir 4.

The filter holder 5 substantially has the shape of a cone with the apex down. This renders it suitable for accommodating commercially available paper coffee filters.

Furthermore, a wall cavity 8 with a small, substantially constant width is present all around the filter holder 5 between the water reservoir 4 and at least a portion of the filter holder 5. This offers the advantage on the one hand that the water reservoir closely adjoins the filter holder 5, so that very little space remains unused, and on the other hand that there is little loss of heat from the filter holder 5 to the still cold water in the water reservoir 4.

The water reservoir 4 is provided with a water level gauge 43. The water reservoir 4 in the coffee maker 1 as shown entirely surrounds the filter device 5, viewed from an upper side of the coffee maker. This renders it possible to provide the water level gauge 43, which is placed at a lateral side of the coffee maker in the known devices, as well as the coffee jug 9 at a front 13 of the coffee maker 1, so that the coffee maker can be operated equally well by left-handed and right-handed persons, while also the water level gauge window can be equally easily read by both groups.

A lowermost graduation of the water level gauge 43 is situated above the coffee jug 4. The portions of the water reservoir situated below said graduation have a volume which can contain at most a minimum quantity of water necessary in the reservoir previous to coffee making. It is indeed not necessary to place the water reservoir entirely above the coffee jug, because reading of a lower level than a level corresponding to the required minimum quantity of water is not necessary. This means that a portion of the water reservoir may be situated at a level with or lower than the coffee jug, so that the center of gravity of the appliance is kept low and/or the capacity of the reservoir 4 is increased.

FIG. 2 shows the lower portion of the filter holder 105 and a residual space 106 provided in the water reservoir 104 in an alternative embodiment of a coffee maker according to the invention. A filter container 107 which keeps the filter holder 105 in position and which is substantially formed by wall portions of the water reservoir 104 encloses at least a lower portion of the filter holder 105 in a manner impassable to liquids. The filter container 107 is provided at a lower side with a holder outlet 172 which is closed off in the non-operational state and which is released in the operational state by a drip stopper 173. If the drip stopper 173 closes off the holder outlet 172 for a longer period while coffee is being prepared, the filter container 107 will become full of coffee and will flow over. The filter container 107 is provided with an overflow 171 by means of which an escape of coffee from the appliance at the upper side of the filter container 107 is prevented. The water reservoir 104 does not merge directly into the filter container locally at the level of a lower region of the filter container 107, but a local intermediate space 109 between the water reservoir 104 and a lower portion of the filter container 107 is provided so as to have a possibility of discharging coffee flowing from the overflow.

1. A coffee maker comprising:
a water reservoir (4; 104) provided with a water fill opening (41) and a reservoir outlet (11);
a heater-pump (12) for heating and supplying water, with an inlet (14) which is connected to said reservoir outlet (11) and with an outlet (15); a filter holder (5; 105) with a filter inlet (51) connected to said heater-pump (12) and a filter outlet (52), which filter holder (5; 105) has an upper portion (54) which has a larger horizontal cross-sectional surface area than a lower portion (55) thereof; and
at least in an operational state, a coffee jug (9) underneath said filter holder (5; 105), which jug (9) has an inflow opening (91) for receiving coffee downstream of said filter outlet (52),
while at least a portion of the water reservoir (4; 104) is situated next to the filter holder (5; 105),
characterized in that that portion of the water reservoir (4; 104) which is situated next to the filter holder (5; 105) extends from the level of said lower portion (55) of said filter holder (5; 105) up to laterally of said upper portion (54) of said filter holder (5; 105).

2. A coffee maker as claimed in claim 1, wherein said water reservoir (4; 104), viewed from an upper side of said coffee maker (1), fully surrounds said filter holder (5; 105).

3. A coffee maker as claimed in claim 1 or 2, wherein a wall cavity (8) with a small, substantially constant width is present between said water reservoir (4; 104) and at least a portion of said filter holder (5; 105).

4. A coffee maker as claimed in any one of the preceding claims, wherein said filter holder (5; 105) substantially has the shape of a cone with the apex down.

5. A coffee maker as claimed in any one of the preceding claims, further comprising a filter container (107) which keeps said filter holder (105) in position, while said filter container (107) surrounds at least a lower portion of said filter holder (105) in a manner impassable to liquids, and said filter container (107) is provided with an overflow (171) and a holder passage (172), which holder passage (172) is provided with a drip stopper (173).

6. A coffee maker as claimed in any one of the preceding claims, wherein said water reservoir (4; 104) extends substantially above said beverage holder (9).

7. A coffee maker as claimed in any one of the preceding claims, further comprising a water level gauge (43) of which a lowermost graduation is situated above the coffee jug (9), while portions of said water reservoir (4) situated below said graduation contain at most a minimum quantity of water whose presence is necessary in the water reservoir (4) previous to coffee making.

8. A coffee maker as claimed in any one of the preceding claims, further comprising a housing (2, 3) with a base (2) and, at a rear side of said base (2), a portion (3) rising from said base and supporting the water reservoir (4), wherein the water level gauge (43) and the coffee jug (9) are both centrally situated at a front of the coffee maker (1) in the operational state.
